(19) United States
(12) Patent Application Publication
(10) Pub. No.: US 2001/0048854 A1
(43) Pub. Date: Dec. 6, 2001

(54) Apparatus and method for jet grouting

(76) Inventor: Ernest E. Carter JR., Sugar Land, TX (US)

Correspondence Address: Patricia A. Kammerer, HOWREY SIMON ARNOLD & WHITE, LLP, 750 Bering Drive, Houston, TX, 77057-2198, US

(21) Appl. No.: 09/756,809

(22) Filed: Jan. 9, 2001

Related U.S. Application Data
(60) Provisional application No. 60/175,759, filed on Jan. 12, 2000.

(51) Int. Cl. E04B 1/00; E04G 21/00; E04G 23/00; E02D 3/12; C09K 17/00; E02D 5/18

(52) U.S. Cl. 405/266; 52/742.16; 405/269

(57) ABSTRACT

A jet bit for jet grouting is disclosed. The jet bit has a rotating auger with a hollow central mast and one or more at least partial helical flights defining an outer auger diameter. The jet bit has at least one primary jet nozzle flowably connected to the central mast of the auger and positioned proximal to the outer diameter of the auger with the discharge of the nozzle directed outside the outer diameter of the auger. Secondary jet nozzles may be used that are directed between the central mast and the outer diameter of the auger. A conventional crane mounted caisson drilling rig can be adapted for use with the jet bit to perform jet grouting.

This patent application claims priority to and specifically incorporates by reference U.S. Provisional Patent Application Ser. No. 60/175,759, filed Jan. 12, 2000.

### BACKGROUND OF THE INVENTION

In civil construction, the jet grouting process is used to form structural or water proof columns of soil mixed with a binder such as Portland cement. In particular, jet grouting refers to a subterranean soil modification technique that uses high pressure jets of grout sprayed from nozzles on a moving drill shaft to impinge soil with such force that the soil is disrupted by the jets and mixed with the grout. Rotation and vertical displacement of the nozzles creates a vertical column of soil/grout mixture in the ground. As an example, single phase jet grouting is generally performed by spraying a cement/water slurry (grout) from jet nozzles in a drill pipe rotating at uniform speed and lifted in uniform increments at timed intervals. This jet grouting is generally performed while the drill pipe is being raised out of a 3 to 5 inch diameter hole, which was drilled by mechanical action or fluid drilling.

Large volumes of excess soil/slurry mixture flow up the annulus between the drill pipe and the drilled hole as the column is formed. The slurry typically has a high water content that ensures that these spoils remain sufficiently liquid to come up the annulus without building up subterranean pressure.

The jet nozzles are generally flush mounted to the pipe with their spray directed perpendicular to the pipe. Using jet nozzles that will typically have a diameter of from 0.06 to 0.09 inches, a right circular column, 28 to 36 inches in diameter (for a four inch diameter drill pipe) is formed of mixed soil as the system is raised out of the ground. Columns are typically less than a meter in diameter. The diameter of the column is limited by the dispersion of the jet energy as it travels through the soil and slurry mixture.

The typical jet nozzles will spray the cement water slurry at pressures of from 1,000 psi to 10,000 psi, more commonly 4,000 psi to 6,000 psi, and will disrupt the soil out to a distance of 12 to 16 inches. This distance is referred to as the jet radius. The jet radius is how many inches of soil the jet penetrates through and mixes. If a rotating 4 inch diameter drill pipe with flush mounted jets forms a column 28 inches in diameter, then its jet radius is 12 inches. The effective range of the jet in soil, which is defined herein as jet radius, is a function of the jet nozzle diameter, the total kinetic energy of the fluid ejected, the density of the soil/slurry material the jet must pass through, and the erosion resistance of the native soil.

The diameter of the columns formed may be dramatically increased by adding a jet of air around the fluid jet. This reduces the net density of the grout slurry/soil mixture thus reducing its ability to adsorb and dissipate the jet's kinetic energy. This approach, however, adds considerable time, expense, and complexity to the process. In addition to these problems, the conventional practice of jet grouting has required specialized drilling rigs, automation, and concentric string drill pipes which are too costly for general contractors to own.

It would be desirable to have a jet grouting apparatus that could be used to produce columns in excess of one meter. It would also be desirable to have a jet grouting apparatus that could be adapted for use with equipment commonly available to general contractors, such as commonly available drill shaft equipment and standard oil field service equipment.

### SUMMARY OF THE INVENTION

In accordance with one aspect of the invention, there is provided a jet bit for jet grouting. The jet bit has a rotating auger with a hollow central mast and one or more at least partial helical flights defining an outer auger diameter. The jet bit has at least one primary jet nozzle flowably connected to the central mast of the auger and positioned proximal to the outer diameter of the auger such that discharge from the nozzle is directed outside the outer diameter of the auger. Optionally, at least one secondary jet nozzle is used that is flowably connected to the central mast of the auger and positioned such that discharge from the nozzle is directed between the central mast and the outer diameter of the auger. Removable teeth can be positioned on the leading edge of the auger and a replaceable tip can be placed on the distal end of the central mast to aid in penetration of the soil.

In accordance with another aspect of the invention, there is provided a crane mounted caisson drilling rig and a jet bit that are combined in one apparatus used for jet grouting. The crane mounted caisson drilling rig has a crane house, a crane boom, a rotary table, an extendable and retractable primary cable, and a bar with an upper end and lower end. The bar, such as a hollow kelly bar, is rotatably attached at the upper end to the primary cable and passes through and is rotated by the rotary table. A jet bit, such as that previously described, is connected to the lower end of the kelly bar. The apparatus also has a fluid swivel for providing grout to the jet bit.

In accordance with another aspect of the invention, there is provided a jet grouting process that employs the combined crane mounted drilling rig and a jet bit apparatus previously described.

### BRIEF DESCRIPTION OF THE DRAWINGS

FIG. 1 depicts a jet bit in accordance with one aspect of the invention.

FIG. 2 depicts the rotation of the jet bit of FIG. 1.

FIG. 3 depicts a jet bit adapted for use with a crane mounted caisson drilling rig in accordance with one aspect of the invention.

FIG. 4 depicts the attachment of a hollow kelly bar to the primary cable of the crane mounted caisson drilling rig in FIG. 3 as well as the placement of a fluid swivel for providing grout to the kelly bar.

FIG. 5 depicts the attachment of a jet bit to the bottom of a kelly bar in accordance with one aspect of the invention.

### DESCRIPTION OF ILLUSTRATIVE EMBODIMENTS

In accordance with one embodiment of the present invention, there is provided a jet bit that can be used in a jet grouting process to obtain large diameter columns. The jet bit is a rotating auger with one or more at least partial helical flights. The jet bit has one or more high pressure jets for spraying grout at least predominantly outside of the swept outer diameter of the auger. The sprayed grout impinges and mixes with the soil.

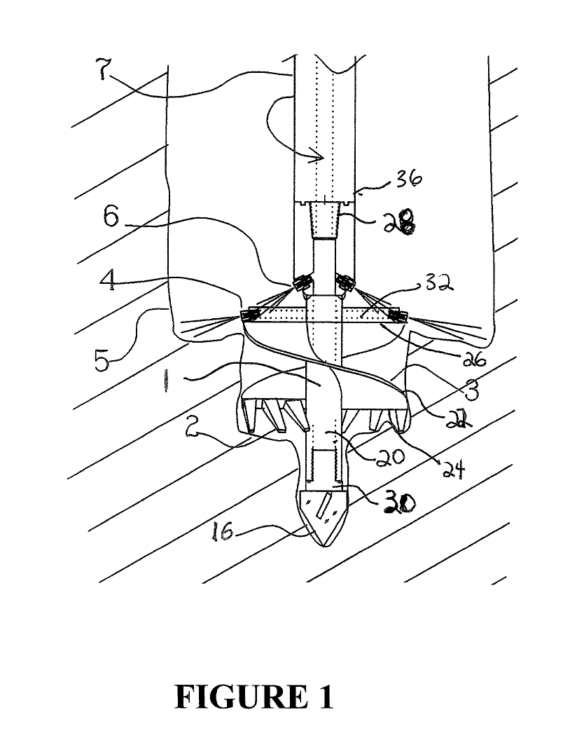

In one variation, by reference to FIG. 1, the jet bit 1 will have a rotating auger 3. The auger 3 will have a hollow central mast 20 and one of more at least partial helical flights 22 that define an outer diameter of the auger 3. In various embodiments, the auger 3 may have multiple flights 22. The flights 22 thus define a leading edge 24 and trailing edge 26 of the auger 3. The auger 3 aids in the penetration of the soil. In various embodiments, the lowest auger flight may have at least one tooth 2, preferably multiple teeth, on the leading edge to further aid in the penetration of the soil. Preferably, the tooth 2 will be replaceable. The central mast 20 has a connector end 28 and a distal end 30 opposite the connector end 28. The jet bit 1 may have tip 16, preferably removable, positioned at the distal end 30 that serves as a pilot for the jet bit 1.

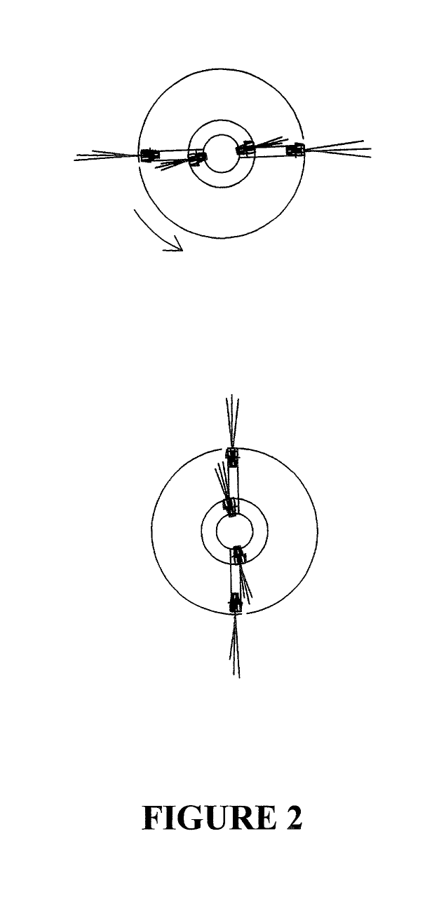

At least one primary jet nozzle 4 is positioned proximal to the outer diameter of the auger 3. The primary jet nozzles 4 are positioned such that their discharge (or spray) is primarily outside the outer diameter of the auger 3. In FIG. 1, primary jet nozzles are shown proximal to the trailing edge 26 of the auger 3, but other positions are contemplated. These jets cut through the soil out to the final diameter 5 of the column to be formed. Secondary jet nozzles 6 can optionally be positioned so as to direct their discharge toward the smaller volume of soil which comes up through the auger flights 22 due to the rotation of the jet bit 1. The discharge of these secondary nozzles 6 is thus primarily between the central mast 20 and the outer diameter of the auger 3. These secondary jet nozzles 6 can be positioned proximal to the outer diameter of the auger 3 or at another location, including, as shown in FIG. 1, on the central mast 20 of the jet bit 1. The jet bit 1 is connected at the connector end 28 to a pipe or bar 7 that can be rotated. This rotation causes the jet bit 1 to move into and out of the soil. Rotation of the jet bit 1 is depicted in FIG. 2.

A cement water slurry (grout) must be supplied to the jet nozzles. This is most easily accomplished as shown in FIG. 1 by using an auger 3 with a hollow central mast 20 and a pipe or bar 7 that is also hollow. With the jet nozzles flowably connected to the hollow central mast 20, for example by a fluid conduit 32, grout can pass through the pipe or bar 7, into the hollow central mast 20 of the auger 3, and out through the jet nozzles. Of course, transfer means for the grout can be positioned external to the pipe or bar 7, and such is within the scope of the present invention, but such placement subjects the transfer means to greater wear and tear.

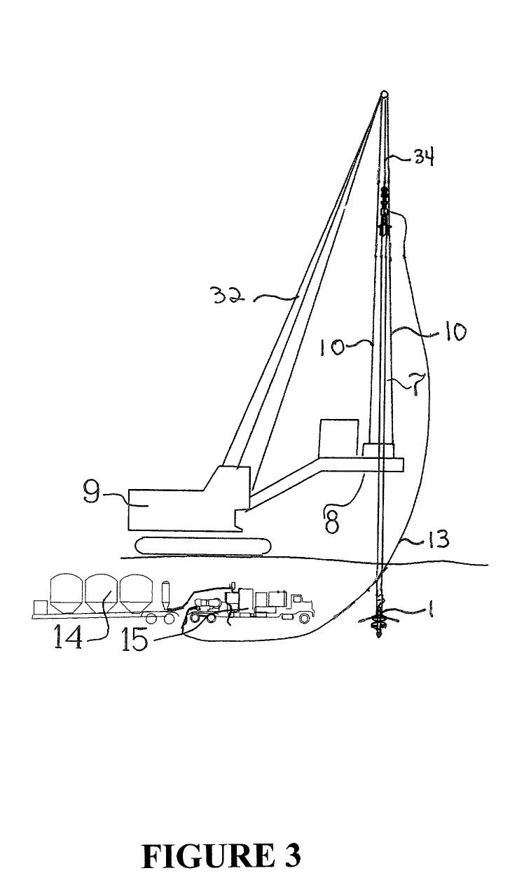

In accordance with another embodiment of the present invention, the jet bit of the invention is adapted to an apparatus which allows a general contractor to utilize commonly available drilled shaft equipment and standard oil field service equipment, such as a drill mounted on a crane, to perform large scale jet grouting of large diameter columns at higher productivity rates than conventional methods. The embodiment allows manually controlled systems to produce high quality work without costly modification to conventional auger drill equipment. The apparatus of this embodiment may be very useful for soil stabilization, treatment of contaminated soils, construction of barrier walls, structural pilings, and construction of structural subterranean walls. Such a combined apparatus is depicted in FIG. 3.

In FIG. 3, a rotary table type crane mounted caisson drilling rig is adapted to perform jet grouting. Such a rig will typically have a crane house 9, a crane boom 32 extending from the crane house 9, a rotary table 8 attached to the crane house and positioned below the top of the crane boom 32, and a extendable and retractable primary cable 34 extending from the crane house 9 to the top of the crane boom 32 and to a pipe or bar 7. In such a rig, the pipe or bar 7 is typically a square cross section kelly bar which is raised and lowered by the crane through the motor driven rotary table 8 which can rotate the kelly bar 7 through contact rollers which allow the kelly bar 7 to move up or down freely while rotational torque is applied. The rotary table 8 is typically attached to a support cable 10, preferably two support cables, running from the crane house 9 to the top of the crane boom 32 and then to the rotary table 8. The kelly bar 7 performs a function similar to a drill pipe in other types of drilling apparatus. A jet bit 1, preferably one with an auger 3 such as previously described, is attached to the kelly bar 7, with the connection being made between the lower end 36 of the kelly bar 7 and the connector end 28 of the jet bit 1. The kelly bar 7 is lowered and rotated causing the jet bit 1 to descend into and penetrate the soil.

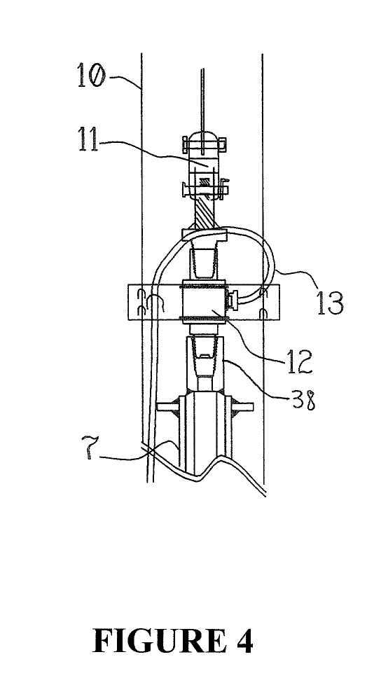

Attachment of the kelly bar 7 to the crane 9 is depicted in FIG. 4. The upper end 38 of the kelly bar 7 is rotatably attached to the extendable and retractable primary cable of the crane 9, preferably through a simple mechanical swivel 11 that compensates for cable twist due to the changing weight on the cable as the kelly bar 7 is raised or lowered. Sometimes the kelly bar 7 is made of two telescoping sections. In the preferred embodiment, the kelly bar 7 is preferably welded so that it does not telescope and so that it will hold high pressure. Preferably, the kelly bar 7 is hollow for the reasons previously explained.

Adapters are welded to the upper and lower end of the kelly bar 7 to accommodate connection to the primary cable (i.e., through the mechanical swivel) and the jet bit 1, respectively. Preferably the adapters are threaded connections with or without locking devices. It is preferable that locking devices are used so that a jet bit 1 comprising a large auger flight will not unscrew underground if the operator reverses the direction of rotation. Optionally, the connection may be one in which the jet bit 1 slides into a seal bore with o-ring or other high pressure seal systems. A locking pin or other device secures the two parts together and is able to withstand full rotational force of the rotary table 8 but only limited vertical pull force. This allows the crane to reverse rotate or pull the kelly bar 7 out of the jet bit 1 and leave it behind if the jet bit 1 becomes stuck deep underground.

A high pressure fluid swivel 12 provides grout to the jet bit. The fluid swivel is preferably positioned adjacent the upper end 38 of the kelly bar 7, more preferably between the mechanical swivel 11 and the upper end 38 of the kelly bar 7. Placement of the fluid swivel 12 in other positions is contemplated and is within the skill of one in the art having the benefit of this disclosure. This fluid swivel 12 is connected to a high pressure hose 13 which runs down to the ground and to a high pressure grout pump 15 (FIG. 3). The grout is preferably provided to the high pressure grout pump 15 from a bulk grout unit 14. In a preferred embodiment, the fluid swivel 12 is also slidably attached to support cables 10. This restrains the fluid swivel 12 itself from rotating as the kelly bar 7 turns.

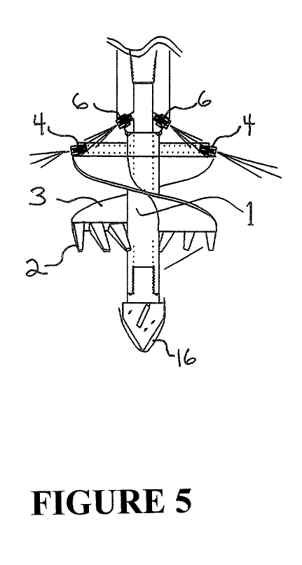

As shown in FIG. 3 and in greater detail in FIG. 5, a jet bit 1 is attached at the connector end 28 of its central mast 20 to the lower end 36 of the kelly bar 7. This jet bit or “bit” or “auger bit” or “mixing head” is designed to drill into the earth and provide a downward pull due to the rotation and weight of the kelly bar 7. Primary jet nozzles 4 and secondary jet nozzles 6 are arranged as previously described on the jet bit 1 to disrupt and mix the soil with the grout slurry. The grout slurry comes from the high pressure pump 15 up the hose 13 to the fluid swivel 12 and is conducted down through the kelly bar 7 to the jet bit 1.

In accordance with another embodiment of the present invention, the jet bit 1 is employed in a jet grouting process. The process can be employed with different operations of scale but is described for convenience in terms of the rotary table type crane mounted caisson drilling rig of the previous embodiment. Accordingly, the term high pressure, for present purposes, will preferably mean within the range of 1,000 psi to 10,000 psi. However, the process of this embodiment is not limited to pressures below 10,000 psi. Pressures above 10,000 psi are sometimes useful and are feasible for the pumps, but flexible hoses rated for higher pressures are generally to costly and heavy for practical use.

In the present embodiment, the jet grouted column is preferably formed on the way down. This provides a much larger pathway for spoils to return to the surface which in turn allows those spoils to be very stiff without causing pressure to build up under ground. The jet bit 1 will preferably have an auger 3, as previously described, to pull the jet bit 1 down into the ground as the drill is rotated. The crane drill machine's hoist cable brake mechanism provides a restraining force which limits and thus controls the downward speed of the drill apparatus. Manual control of the cable brake system may be calibrated with a timer or an audio signal which assists the operator in lowering the drill at a sufficiently uniform rate. Actually the operator is simply controlling the tension of the cable to modify the penetration speed. Optionally, the rate of lowering of the bit can be controlled by a semi-automatic system such as on a hydraulically operated crane which allows the downward speed to be set at a relatively constant rate. Various line speed indicators and RPM indicators may be used to allow the crane operator to stay at a sufficiently uniform speed. Speed variations less than 25 percent generally do not have much affect on column quality.

The jet bit 1 may take the form of a heavy steel drill bit with spiral grooves or may resemble an auger flight wrapped around a tubular core. In softer soils where the weight of the kelly bar 7 is sufficient to produce the needed downward thrust the jet bit 1 may not require any auger flights, and the point may resemble those used for oil well drilling. The jet bit 1, as previously disclosed, may also include a removable tip 16 for ease of cleaning and replacement of wear surfaces. The tip 16 also serves as a pilot to help the drill move in a straight path. The tip 16 may optionally have a jet nozzle positioned on it to aid in cutting.

Jet nozzles on the jet bit 1 blend cement slurry into both the soil which has been disturbed by the auger 3 and undisturbed soil outside of the swept area of the auger 3. Jet nozzles are preferably contained in threaded inserts that screw into the jet bit 1 for easy replacement. The jet nozzles are preferably 1/8 inch or larger in size which is a larger diameter than those typically used in jet grouting. The larger jet size requires more horsepower but increases the penetration depth of the jet and makes it less susceptible to plugging by solids in the slurry. The primary jet nozzles 4 are preferably located at least a foot above the bottom of the slurry conduit. Solids which could otherwise plug these jet nozzles 4 fall down past the nozzle openings and collects in the lower portion of the jet bit 1. The rotational speed of the jet bit 1 is preferably designed such that each rotation lowers the jet bit 1 a distance which can be completely eroded by the jets. The primary jets 4, which are preferably proximal to the outer swept diameter of the auger flight, disrupt and mix soil out to a larger diameter because they begin on a larger diameter. This allows a larger column to be formed without the use of air or multiple fluids. Secondary jet nozzles 6, as previously described, can be used.

For even larger columns it is possible to introduced air or some other gas into the grout and thus into the process without multiple passageway drill pipes as follows: The high pressure pumps used in this work will generally not tolerate compressible gas entrained fluids so the gas will normally be added downstream of these pumps. Gas in the fluid tends to make the high pressure pump shake itself apart. In the present embodiment, the gas, preferably air, is added upstream of the high pressure pumps but then the slurry is pre-compressed with a medium pressure boost pump before delivering it to the high pressure pumps. At 200-400 psi the entrained gas volume will shrink enough that it will not undergo significant further compression in the high pressure pumps. The use of surfactant agents in the grout to help make the bubbles as small and as uniformly dispersed as possible also minimizes the difficulty with the high pressure pumps. Common lignosufonate or air entraining admixtures can provide the needed stable foam surfactant properties. The slurry is preferably mixed to a specific density with a primary mixer system prior to adding of the surfactant. A second open air mixing step adds just enough of the surfactant to reduce the density of the grout, by entraining gas, to achieve the desired lighter density of the gas entrained mix. A density reduction of from ten to fifty percent is preferred. The gas entrained grout slurry is then fed to a boost pump which pressurizes it to several hundred psi for delivery to the high pressure pumps. An in-line density measuring device can verify that the slurry is compressed back to sufficiently close to its original non-gas entrained liquid density prior to entering the high pressure pumps. The boost pump pressure will be altered to achieve whatever level of compression is required to prevent damage to the high pressure pumps. When this gas entrained slurry is ejected from the jets it will produce greater jet penetration due to reduction in the density of the mix, just as the coaxial air jets do in conventional two phase jet grouting.

Very large jet grouted columns can be formed by use of a 36 inch diameter auger with primary jet nozzles 4 proximal to the outer diameter of the auger. These jet nozzles 4 can impinge soils another 18 inches outside the outer diameter of the auger. This will produce a jet grouted column of 6 foot diameter. The soil within the swept area of the auger 3 may be mechanically mixed entirely by the auger 3 or may be mixed by one or more secondary jet nozzles 6 as previously described. The mixing process may be continued on the way up out of the hole.

The jet nozzles are preferably oriented about 180 degrees apart. Preferably the jet nozzles are also positioned such that the angle formed between the nozzles and the distal end 30 of the central mast 20 is less than 90 degrees. Angling of the jet nozzles in this fashion, e.g., 15 degrees less than perpendicular to the central mast, is beneficial because when the jet bit 1 is raised above ground the spray from the jets will not present a hazard to workers. When the jet bit 1 is out of the ground, a deflector cover may be attached to fully contain or deflect the force of the jets. This enables the jets to be run so they may be run at full pressure for cleaning.

The grout slurry for forming structural columns is preferably a Portland cement and water mixture. In order to make higher strength columns, a lower water content is preferably used. Use of low cost water reducing admixtures such as sodium lignosufonate or calcium lignosufonate are desirable to reduce the viscosity of the slurry without adding more water.

When jet grouting is conducted in a hazardous or radioactive waste landfill, a jet bit 1 with a relatively small diameter auger may be used to help penetrate through debris better. The crane mounted auger drill units typically have much more power than conventional drilling equipment and can thus drill through debris that would stop a conventional hammer drill. Since the kelly bar 7 of such a drill is essentially one piece, workers do not have to make drill pipe connections. The unit simply plunges into the ground to the required depth and back to the surface.

For radioactive waste the grout would preferably be a film-forming material such as the molten wax described in U.S. Pat. No. 5,879,110. Use of such a material captures everything it touches and thus prevents contaminated soils that are brought to the surface on the jet bit 1 or kelly bar 7 from becoming airborne contaminants. The permeation characteristics of such grouts also help encapsulate chunks of soil and debris that are not broken up into fine particles by the jets.

The above jet grouting process may be utilized to place columns of a reactive zero valent iron or other reactive agent for the remediation of contaminated ground water. The iron would preferably be mixed with a guar gum and water solution in a pre-mix tank. A solution of borax or other cross-linking agent would preferably be added to the slurry directly at the eye of the centrifugal pump feeding the high pressure pumps. Jet nozzle size would be increased to compensate for the larger iron particles commonly preferred.

A multi-stage jet bit 1 could be constructed by placing another set of jets on a larger diameter above the primary jets 4. For example, a 12 inch diameter bottom auger 3 cuts a 12 inch hole and provides down force. If jet radius is 14 inches, the primary jets 4 on its top perimeter extend the jetted diameter out to 40 inches. A boom just shorter than this jetted diameter, e.g., 38 inches, can be positioned above the primary jets 4 and perpendicular to the central mast. Supplemental jets flowably connected to the hollow kelly bar 7 or to the hollow central mast can be positioned at one or both of the ends of the boom. These supplemental jets allow for a column that is 66 inches in diameter. Additional booms and jets above this could extend the diameter further.

What is claimed is:

1. A jet bit for jet grouting comprising a rotating auger with a hollow central mast having a connector end and a distal end opposite the connector end, a leading edge and a trailing edge, and one or more at least partial helical flights positioned between the leading edge and trailing edge and defining an outer auger diameter; and at least one primary jet nozzle flowably connected to the central mast of the auger and positioned proximal to the outer diameter of the auger such that discharge from the nozzle is directed outside the outer diameter of the auger.

2. A jet bit in accordance with claim 1 further comprising at least one secondary jet nozzle flowably connected to the central mast of the auger and positioned such that discharge from the nozzle is directed between the central mast and the outer diameter of the auger.

3. A jet bit in accordance with claim 1, wherein the auger has at least one tooth positioned on the leading edge of the auger.

4. A jet bit in accordance with claim 3, wherein at least one tooth is replaceable.

5. A jet bit in accordance with claim 1, wherein at least one primary jet nozzle is positioned proximal to the trailing edge of the auger.

6. A jet bit in accordance with claim 1 further comprised of a tip positioned at the distal end.

7. A jet bit in accordance with claim 6, wherein the tip is removable.

8. A jet bit in accordance with claim 6, wherein the tip has positioned thereon a jet nozzle.

9. An apparatus for jet grouting comprising a jet bit in accordance with claim 1 and further comprising:
a crane mounted drilling rig comprising a crane house, a crane boom, a rotary table, an extendable and retractable primary cable, and a bar with an upper end and lower end, wherein the bar is rotatably attached at the upper end to the primary cable and passes through and is rotated by the rotary table;
a fluid swivel for providing grout to the jet bit;
wherein the connector end of the central mast of the jet bit is connected to the lower end of the bar of the drilling rig.

10. An apparatus for jet grouting comprising:
a crane mounted drilling rig comprising a crane house, a crane boom, a rotary table, an extendable and retractable primary cable, and a bar with an upper end and lower end, wherein the bar is rotatably attached at the upper end to the primary cable and passes through and is rotated by the rotary table;
a jet bit comprising a rotating auger with a hollow central mast having a connector end and a distal end opposite the connector end, a leading edge and a trailing edge, and one or more at least partial helical flights positioned between the leading edge and trailing edge and defining an outer auger diameter; and at least one primary jet nozzle flowably connected to the central mast of the auger and positioned proximal to the outer diameter of the auger such that discharge from the nozzle is directed outside the outer diameter of the auger; and
a fluid swivel for providing grout to the jet bit;
wherein the connector end of the central mast of the jet bit is connected to the lower end of the bar of the drilling rig.

11. The apparatus of claim 10, wherein the bar of the drilling rig is hollow.

12. The apparatus of claim 10, wherein the bar is a kelly bar.

13. The apparatus of claim 10, wherein the fluid swivel is positioned adjacent the upper end of the bar.

14. The apparatus of claim 10, wherein the primary cable and the bar are connected by a mechanical swivel.

15. The apparatus of claim 14, wherein the fluid swivel is positioned between the mechanical swivel and the upper end of the bar.

16. The apparatus of claim 10 further comprising at least one support cable extending from the crane house to the crane boom and then to the rotary table.

17. The apparatus of claim 16, wherein the at least one support cable is slidably attached to the fluid swivel.

18. The apparatus of claim 10 further comprised of a boom positioned above the trailing edge of the auger and perpendicular to the central mast, wherein at least one supplemental jets flowably connected to the central mast are positioned on the boom.

19. A jet grouting process for forming subterranean columns of soil and grout employing the apparatus of claim 10,
wherein rotation of the bar causes rotation of the jet bit and penetration and descent of the jet bit into the soil,
wherein grout is provided to the fluid swivel and then to the primary jet nozzle, and
wherein grout discharged from the primary jet nozzle impinges with and disrupts the soil thereafter mixing with the soil to form the column.

20. A jet grouting process for forming subterranean columns of soil and grout employing:
a crane mounted drilling rig comprising a crane house, a crane boom, a rotary table, an extendable and retractable primary cable, and a bar with an upper end and lower end, wherein the bar is rotatably attached at the upper end to the primary cable and passes through and is rotated by the rotary table;
a jet bit comprising a rotating auger with a hollow central mast having a connector end and a distal end opposite the connector end, a leading edge and a trailing edge, and one or more at least partial helical flights positioned between the leading edge and trailing edge and defining an outer auger diameter; and at least one primary jet nozzle flowably connected to the central mast of the auger and positioned proximal to the outer diameter of the auger such that discharge from the nozzle is directed outside the outer diameter of the auger; and
a fluid swivel for providing grout to the jet bit;
wherein the connector end of the central mast of the jet bit is connected to the lower end of the bar of the drilling rig;
wherein rotation of the bar causes rotation of the jet bit and penetration and descent of the jet bit into the soil,
wherein grout is provided to the fluid swivel and then to the primary jet nozzle, and
wherein grout discharged from the primary jet nozzle impinges with and disrupts the soil thereafter mixing with the soil to form the column.

21. A jet grouting process in accordance with claim 20, wherein a standard crane braking apparatus provides a controlled resistance to the descent of the bar and jet bit.

22. A jet grouting process in accordance with claim 20, wherein the grout is provided to a high pressure pump and then to the fluid swivel.

23. A jet grouting process in accordance with claim 22, wherein gas is entrained in the grout prior to being provided to the high pressure pump and wherein the grout is pre-compressed prior to being provided to the high pressure pump.

24. A jet grouting process in accordance with claim 23, wherein a surfactant is added to the grout prior to being pre-compressed.

25. A jet grouting process in accordance with claim 20, wherein the grout is discharged at pressures of from 1,000 psi to 10,000 psi.

26. A jet grouting process in accordance with claim 20, wherein the column is formed during the descent of the bar and jet bit.
